(19) United States
(12) Patent Application Publication
(10) Pub. No.: US 2003/0190911 A1
(43) Pub. Date: Oct. 9, 2003

(54) Methods and apparatus for monitoring and controlling a vehicle over a wireless network

(76) Inventor: Clifford Y. Hirano, Huntington Beach, CA (US)

Correspondence Address: Eric K. Satermo, Registered Patent Agent, P.O. Box 19099, Irvine, CA, 92623-9099, US

(21) Appl. No.: 10/115,862

(22) Filed: Apr. 4, 2002

(51) Int. Cl. H04Q 7/20

(52) U.S. Cl. 455/423; 455/425; 455/456.1

(57) ABSTRACT

A mobile location unit (MLU) provides two-way wireless data transmission between vehicles and cellular devices. In one embodiment, a MLU detects the theft of a vehicle. For example, a cellular call with a recorded message may be made to cellular device. The voice message may include several options to control the vehicle. The user may select an option and then control the vehicle through a wireless network without server routing.

### BACKGROUND OF THE INVENTION

The present invention relates to methods and apparatus for monitoring and controlling a vehicle over a wireless network. One of the applications of the present invention is in detecting the theft of a vehicle and for subsequent controlling and monitoring the stolen vehicle on a cellular network.

Conventional systems for detecting the theft of a vehicle are server intensive, inefficient, and inconvenient. Accordingly, there is a need for a system that enables a user to monitor a vehicle, to detect the theft of the vehicle, and to control the vehicle subsequent to the theft, leading to the recovery of the vehicle.

### SUMMARY OF THE INVENTION

A mobile location unit (MLU) provides two-way wireless data transmission between vehicles and cellular devices. In accordance with one aspect of the present invention, a MLU detects the theft of a vehicle. For example, a cellular call with a recorded message may be made to cellular device. The voice message may include several options to control the vehicle. The user may select an option and then control the vehicle through a wireless network without server routing, thereby reducing reaction time.

According to another aspect of the invention, a MLU may receive software upgrade in the MLU on the fly. According to yet another aspect, a user interface provides a tracking feature through the web to allow a user to track a stolen vehicle with real time.

Other aspects and advantages of the present invention will become apparent from the following detailed description, taken in conjunction with the accompanying drawings, illustrating by way of example the principles of the present invention.

### BRIEF DESCRIPTION OF THE DRAWINGS

FIG. 1 illustrates a system for monitoring and controlling a theft;

FIG. 2 illustrates schematically a mobile location unit for a vehicle;

FIG. 3 illustrates two-way communication between a cellular device and a dual-tone multi-frequency module;

FIG. 4 illustrates schematically a server module;

FIG. 5 illustrates schematically interaction among a communication server, a mobile location unit, and a remote access server;

FIG. 6 illustrates schematically communication between a GPS theft vehicle prevention system and various applications; and

FIGS. 7A, 7B, and 7C illustrate methodology for reacting to the theft of a vehicle.

### DETAILED DESCRIPTION OF THE INVENTION

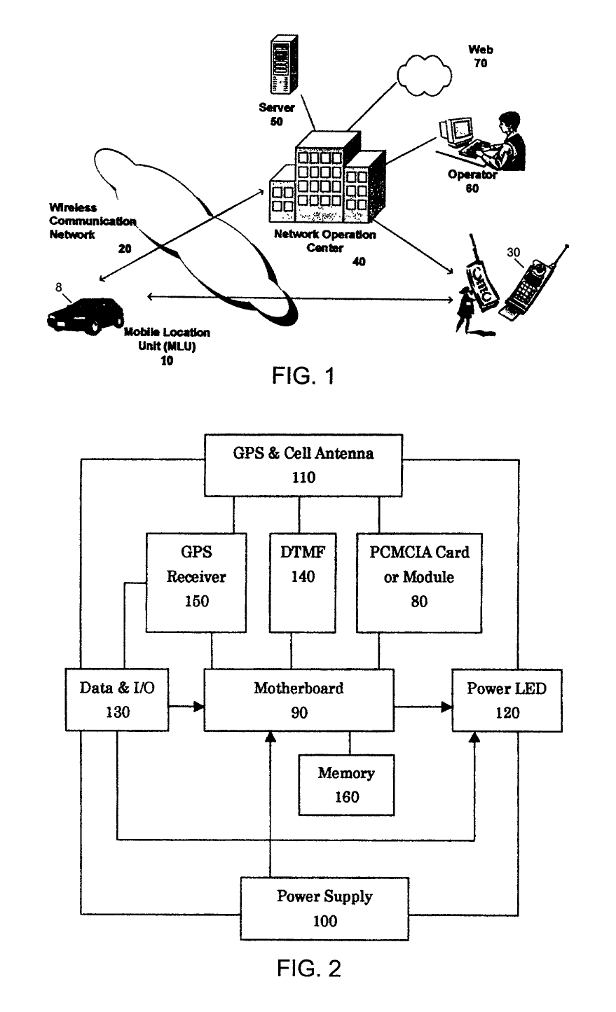

A system for responding to the theft of a vehicle 8 is illustrated in FIG. 1. The vehicle 8 includes a mobile location unit (MLU) 10 configured to monitor various vehicle parameters, for example, door locks and alarms. When a specific event such as a theft of the vehicle 8 is detected, the MLU 10 sends a signal such as a recorded voice message via a wireless network 20 to a cellular device 30, for example, a cellular telephone maintained by the owner of the vehicle 8. The signal sent to the cellular device 30 may be a dual-tone multi-frequency (DTMF) signal so that two-way communication is enabled between the MLU 10 and the cellular device 30. For the purposes of this description, the MLU 10 may also be referred to as a “test terminal.”

The theft-response system may include a network operation center 40 including a server 50 and an operator 60. A user may control the MLU 10 or communicate with other cellular devices 30 through the world-wide web 70. The operator 60 may provide help-desk functions around the clock. Upon receiving a request from a user, the operator 60 may register a telephone number to be automatically called in an emergency.

Referring to FIG. 2, an exemplary MLU 10 may include a wireless card 80 such as a personal computer miniature communications interface adapter (PC-MCIA) card or module, a motherboard 90, a power supply 100, a global positioning satellite (GPS) and cellular antenna 110, a power LED 120, a data input/output (I/O) 130, a DTMF signal generator 140, a GPS receiver 150, and a memory 160.

The motherboard 90 may be configured to accommodate the GPS receiver 150 and the wireless card 80 and may include a processor to host application-layer software for interfacing with the GPS receiver 150 and the wireless card 80. Data logging capacities and I/O logic may also reside on the motherboard 90. According to an exemplary embodiment, the motherboard 90 may control the operation of the entire system in addition to other control processor components.

In addition to GPS tracking and navigation functions, the GPS receiver 150 may provide data including time and location either on command or periodically, which data the GPS receiver 150 may receive and convert to a predetermined format.

The wireless card 80 may send and receive data packets over the wireless network 20, which network may include nationwide commercial CDMA/GSM networks. The MLU 10 may operate on an input voltage range that is able to operate under transients and spikes in accordance with SAE J1455 automotive specifications. The server 50 may generate a test plan. The MLU 10 may operate in accordance with the test plan for measuring parameters of the network, which parameters are discussed below.

According to an exemplary embodiment, the MLU 10 may include a pair of antennas 110. One antenna may be configured for CDMA/GSM data transmission on a CDMS/GSM PCS and cellular band, and one antenna may be configured for GPS functions. The MLU 10 may include SMA connectors for multiple antenna connections, with each connector including appropriate marking. The MLU 10 may include visible indicators 120 such as light-emitting diodes (LEDs) on a front panel for respectively indicating power-on, GPS tracking, and CDMA/GSM service availability.

According to an exemplary embodiment, the MLU 10 may also include connectors located on end plates. A mating cable/connector assembly for power and I/O functions may be provided with each MLU, for example, for GPS, an SMA bulkhead; for cellular, a SMA bulkhead; and for data and I/O, a nine-pin DB9F connector. The DB9 connector may provide an interface for the discrete I/O lines that are monitored and controlled by application software. For example, three input lines may be “read” and two output lines me be “controlled” by the software. The power line may be an automotive quick-connect connector. The power supply 100 may provide various input voltage ranges, with a typical input current operating on a basis of, for example, a 70% power supply efficiency. The MLU 10 may be configured to meet any number of environmental conditions, including storage temperature, operating temperature, operating humidity, shock, and vibration.

The memory 160 may store the system program in addition to necessary parameters periodically or when an event occurs. This data may then be transmitted to the server 50 through the communications network 40. The transmission of data may take place automatically. The memory 160 may also be used as a space for the remote upgrade of software programs embedded in the MLU 10 when a user downloads a new version of the terminal software. Further, the memory 160 may store power-on registration data representing a current test state and may provide this data to software programs when requested. The power-on registration data may include information indicating a data query start, an interruption, an end of the data query in the MLU 10, a telephone number of the server, and other related data.

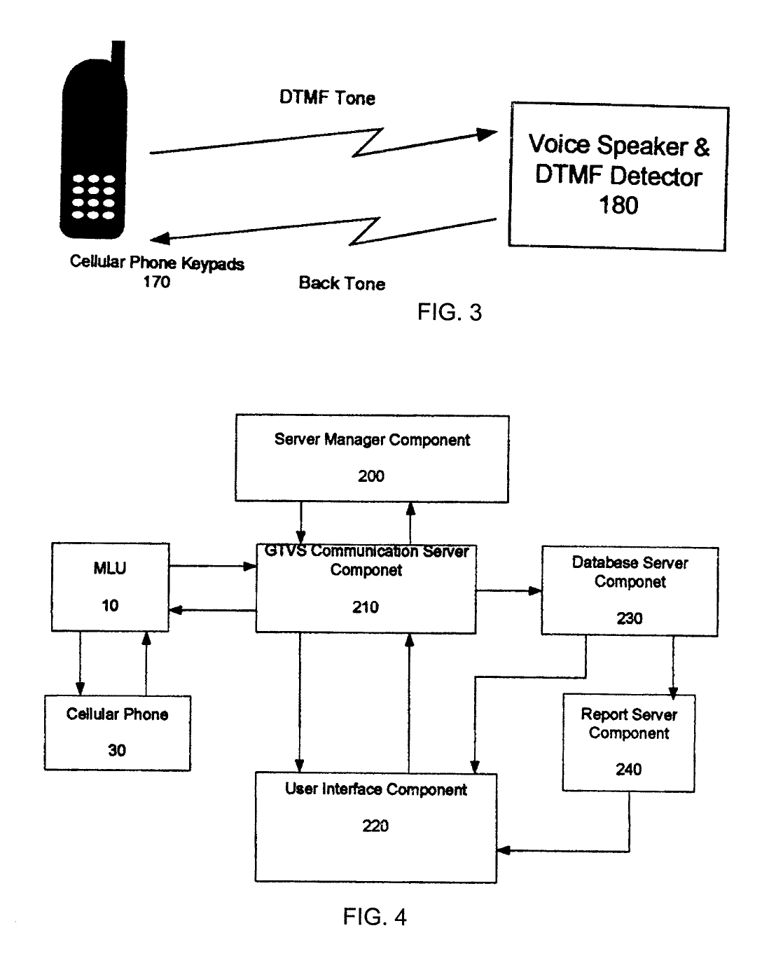

Referring to FIG. 3, two-way communication between a cellular phone 30 and the DTMF module 190 may occur through the wireless communication network 20 and may be implemented with a cellular keypad 170 and a voice speaker and DTMF detector 180.

The dual-tone multi-frequency (DTMF) protocol incorporates a series of tones generated from a keypad 170 of a cellular device 30, which tones are the sum of two sine-wave tones. For example, a conventional cellular phone is able to generate 12 frequencies of DTMF protocol (i.e., 1, 2, 3, 4, 5, 6, 7, 8, 9, 0, *, and #). DTMF protocol enables two-way cellular communication and tone dialing in conventional wired telephones.

The MLU 10 may include automatic voice reply functionality for announcing to a user via the cellular device 30 when an event occurs. In addition, a user may control the vehicle 8 through the MLU 10 by means of the DTMF protocol of the cellular device 30.

With reference to FIG. 4, the server module 50 may include a server manager component 200, a GTVS communication server component 210, a database server component 230, a report server component 240, and a user interface component 220, with each component carrying out a respective function in processing data from the MLU 10. Server components 200, 210, 220, 230, and 240 may be logically connected as well as physically connected and may be installed in either a single server or several servers. The server 50 may be interfaced with a remote access server (RAS) network device (not shown) for controlling incoming calls, termination calls, and data communications between the MLU 10 and the server 50. Details of the RAS network device are provided below.

The server module 250 may communicate with the MLU 10 via TCP/IP to save parameters to the server 50 and to communicate with web client 270. The GTVS communication server component 210 may control MLUs in multiple vehicles, receive logging data and current position in near real time from the MLU 10, inform the MLU 10 of an incoming call from the server 50, and download software.

The GTVS communication server component 210 may be configured to command and control the MLU 10. In an exemplary embodiment, the GTVS communication server component 210 may communicate with the MLU 10 through the RAS. In addition, the GTVS communication server component 210 may send control commands, plan and MLU software to the MLU 10 by placing calls to the test terminal using the RAS. The GTVS communication server component 210 may also receive a current status of the MLU 10 and data files that contain parameters from the MLU 10. When data files are received, the GTVS communication server component 210 may relay the same to the database server component 230. The server manager component 200 may be configured to monitor the resources of the server 50.

The database server component 230 may be configured to save parameters, location data, and event data, as well as to create corresponding reports. The database server component 230 may then receive the summary information and detailed parameters from the GTVS communication server component 210 and store the same in a relational database. The stored information may then be used as a source for the report server component 240 to generate reports, for example, written in HTML. The database server component 230 may store the event history for the MLU 10 from the GTVS communication server component 210. The event history may be utilized later for web pages by the user interface component 220.

The data fields of the database server component 230 may include location information, event and transaction information, user information, vehicle information, MLU information, MLU parameters, and emergency information. More specifically, parameters of the location information may include time, speed, last idle location, start location of when the vehicle was stolen, and current vehicle location. Parameters of the event and transaction information may include time, event number, event ID (e.g., control, notification, tracking, continuous tracking, etc.), notification (e.g., vehicle stolen, vehicle crash, low battery, etc), number of event, and event trigger. Parameters for the user information may include first name, last name, address 1 and 2, city, state, zip, country, time zone, home phone, work phone, observe daylight saving, mobile phone, e-mail address, and security questions. Parameters for the vehicle information may include vehicle manufacturer, model, year, color, vehicle identification number (VIN), state of registration, and license number. Parameters for the terminal (i.e., MLU) information may include ID, serial number, phone number, and type of network. Parameters for the emergency information may include information related to a driver, e.g., first name, last name, e-mail address, doctor's name and phone number, insurance carrier, preferred hospital, blood type, drug allergies, driver's license number, and social security number.

The report server component 240 may be configured to request the database server component 230 for information of based on a user-specified time period, MLU group(s), and geographic zone. The report server component 240 may generate reports, e.g., written in HTML and send such reports to registered users by e-mail. The report server component 240 may generate various reports including statistics over a specified time interval, as well as trends over a predetermined period of time (e.g., daily, weekly, monthly, and so on).

The user interface component 220 may be configured to provide a user interface for any or all of the server components. The user interface component 220 may receive user inputs, send such inputs to server components, and indicate responses from server components on web pages. According to an exemplary embodiment, the user interface component 220 enables a user to operate the system and to view the results of a query including current MLU location and a report.

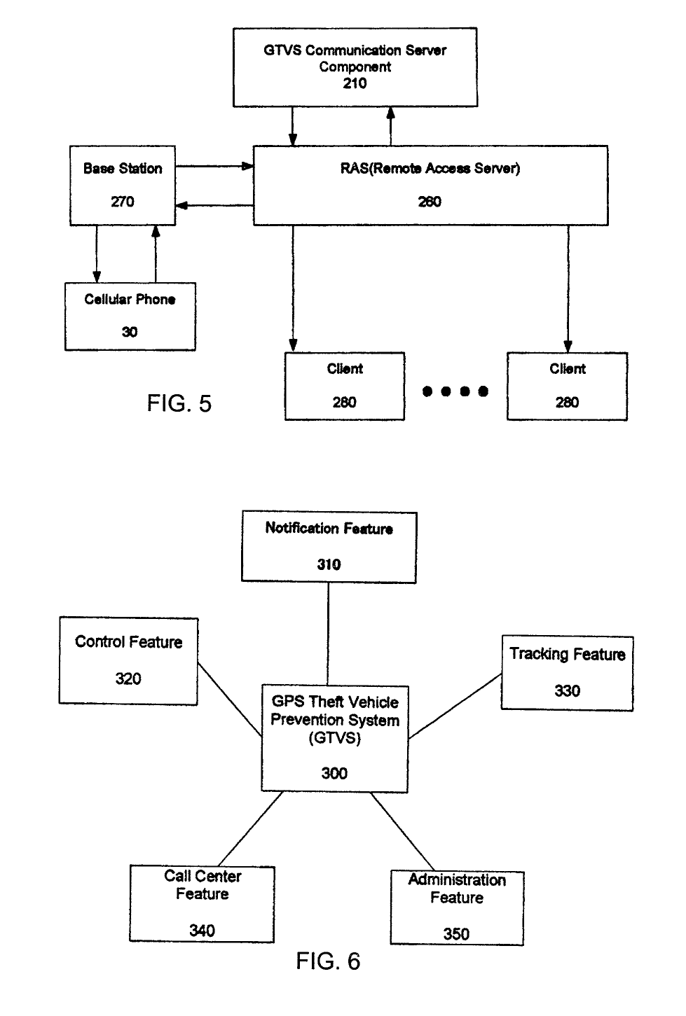

Referring to FIG. 5, interconnectivity among the cellular phone 30, the RAS 260, a client 280 with an MLU 10, and the GTVS communication server component 210 in accordance with an exemplary embodiment of the invention is shown. To place a call from the MLU 10 to the GTVS communication server component 210, the MLU 10 may place a call to the RAS 260 which, upon receipt of the call from the MLU 10, may provide a predetermined static IP address to the MLU 10. The MLU 10 may then register a routing field to the GTVS communication server component 210 to a routing table thereof. The MLU 10 and the GTVS communication server component 210 may then communicate via a PSTN network.

To place a call from the GTVS communication server component 210 to an MLU 10 located at a client 280, the GTVS communication server component 210 may query the database server component 230 about the IP address of the MLU 10. The GTVS communication server component 210 may then configure a packet to the IP address of the MLU 10. The packet may then be sent to the RAS 260. Upon receipt, the RAS 260 may call to the MLU 10 corresponding to the IP address. The phone number of the MLU may be pre-configured by the RAS 260 administrator.

The MLU 10 may then receive a call from the GTVS communication server component 210, and the RAS 260 may provide a predetermined static IP address to the MLU 10. The MLU 10 may then register a routing field to the GTVS communication server component 210 to the routing table thereof. The MLU 10 and the GTVS communication server component 210 may then communicate via PSTN network.

With reference to FIG. 6, an applications flow supported in the GPS theft vehicle prevention system (GTVS) 300 is illustrated. The GTVS may provide various applications to a user with a vehicle notification feature 310, a vehicle control feature 320, a vehicle tracking feature 330, a call center feature 340, and an administration feature 350.

To notify a user of an event such as a theft of the vehicle 8, the GTVS 300 may provide the cellular device 30 of a user a stolen-vehicle notification. To notify a user of other events, the GTVS 300 may provide the user's cellular device 30 an automatic crash notification, a low-battery notification, or a Geo fence violation. The GTVS 300 may provide any number of commands to the MLU 10, include lock car door, unlock car door, remote engine disable, remote starter, honk horns, or flash lights.

If a user desires to know the current location of the vehicle 8, the GTVS 300 may track the vehicle to determine the location when stolen. A user may also monitor the location of the vehicle when operated by a registered driver such as a son or a daughter. The call center 340 may be configured to support stolen vehicle notification, crash notification, vehicle tracking, and driver and vehicle profiles.

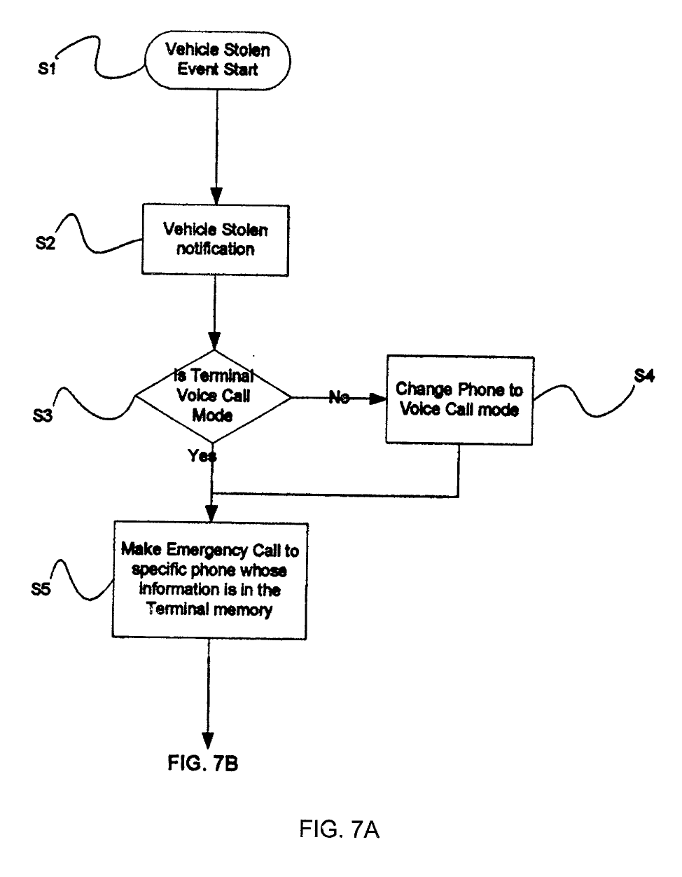

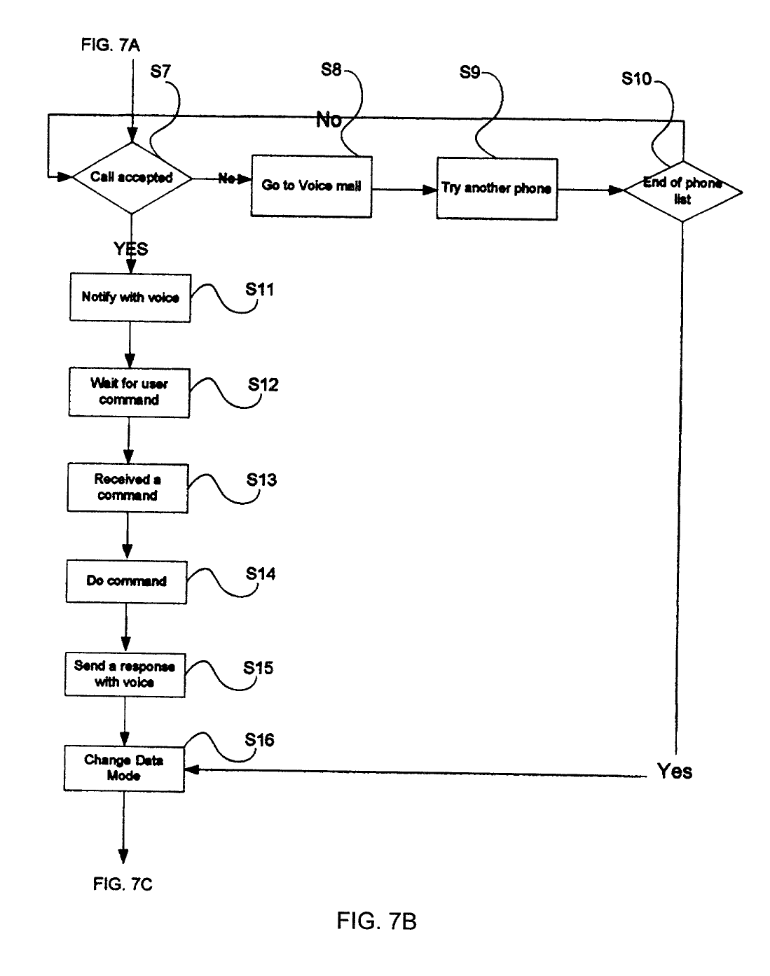

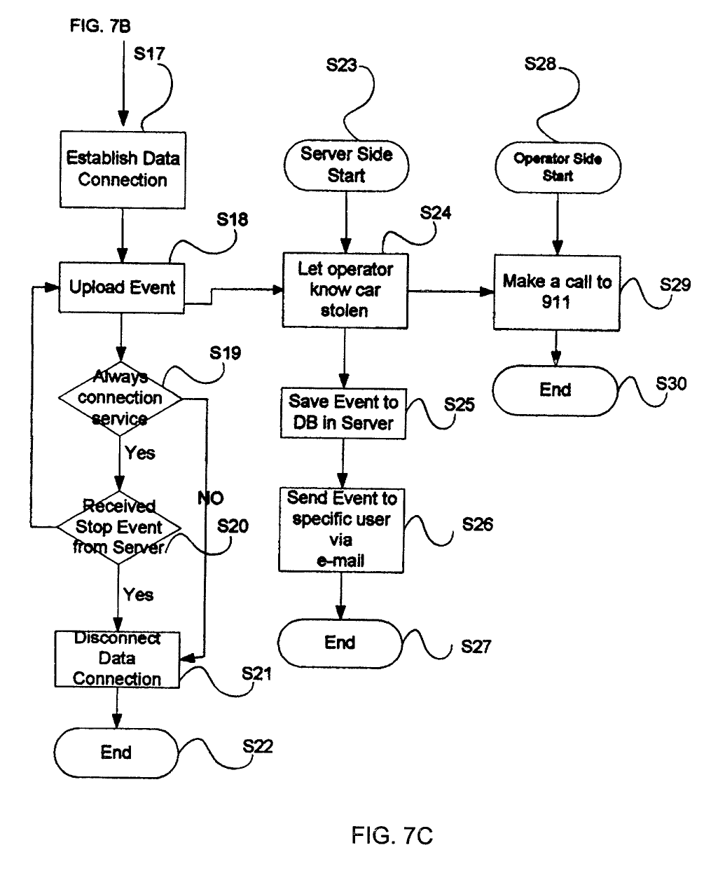

Referring to FIGS. 7A, 7B, and 7C, methodology associated with an event such as a stolen vehicle is illustrated. When the vehicle 8 is stolen (step S1), a notification may be activated (step S2) and a determination may be made whether the MLU 10 is in voice mode or data mode (step S3). If the MLU 10 is in voice mode, then MLU 10 may place a phone call to a specific phone, information for which may be stored is in the memory 160 of the MLU 10 (step S5). If the MLU 10 is in data mode, then the MLU 10 may change the phone mode to voice mode (step S4) prior to placing a phone call (step S5).

When a user accepts a call (step S7), the MLU 10 may provide a notification that the vehicle was stolen, for example, with a recorded voice message (step S11). The MLU 10 may then wait for a user command with a response (step S12). If the user sends a command (e.g., a DTMF message from the cellular device 30), upon receipt at the DTMF detector 180 (step S13), the MLU 10 may then carry out the command (step S14) and send a response to the user (step S15), e.g., a recorded voice message.

If a call is not connected to the specified user (step S7), then the MLU 10 may attempt to place the call again. If the connection cannot be made after repeated attempts, then a recorded voice message may be stored in a voice mail box of the cellular device 30 (step S8). The MLU 10 may attempt to connect with the cellular device of another user specified in the memory 160 (step S9). If the MLU 10 cannot make a connection after attempting each cellular device 30 in a phone list stored in the memory 160 (step S10), then the MLU 10 may change to data mode (step S16).

The MLU 10 may then place a data call and when established (step S17), the MLU 10 may upload event data to the server 50 (step S18). The MLU 10 may maintain the data connection (steps S19 and S20) until instructions are received from the server 50 (steps S20 and S21).

When the vehicle is stolen, the operator 60 at the network operation center 40 may attempt to reach law enforcement authorities immediately and may keep track of the location of the vehicle continuously (see steps S19 and S20).

Upon receipt of event data from MLU 10 (step S18), the server 50 may store the event data in the database server component 230 and notify the operator 60 (steps S24 and S25). The operator 60 may then place a call to law enforcement authorities (step S29) and track the stolen vehicle with the GTVS 300 providing the location through the web 70 in real time. The GTVS 300 may provide vehicle information to law enforcement authorities as well (step S29).

The report server component 240 may then send a generated HTML report including the event history to the registered user by e-mail (step S26). The user may also access such a report through the web 70 (step S26).

The invention is not limited to the specific embodiments described above. Other modifications are also within the scope of the present invention. Accordingly, the present invention is not limited to that precisely as shown and described above. Instead, the present invention is construed according to the claims that follow.

What is claimed is:

1. A method for measuring network parameters of a wireless network according to a test plan with a server and a test terminal, the method comprising:
connecting to the server when the test terminal is activated;
sending registration data indicative of a current state of the test terminal to the server, the current state including start, interruption, and end; and
when a test plan is loaded in the test terminal:
collecting network parameters;
parsing the collected network parameters into sets of network parameters; and
transmitting the sets of network parameters to the server.

2. The method of claim 1 further comprising:
loading the test plan to the test terminal from the server.

3. The method of claim 1 wherein the transmitting step comprises transmitting the set of network parameters when a request is received from the server.

4. The method of claim 1 wherein the transmitting step comprises transmitting the set of network parameters at a predetermined time.

5. The method of claim 1 wherein the test terminal is mobile.

6. The method of claim 1 wherein the collecting step comprises collecting network parameters corresponding to a geographic position of the test terminal.

7. The method of claim 1 further comprising downloading an application program at the test terminal from the server.

8. A system for monitoring a vehicle on a wireless network, the system comprising:
a cellular device;
a server configured to communicate with the cellular device on the wireless network; and
a mobile location unit disposed in the vehicle and configured to communicate with the cellular device and the server on the wireless network;
the mobile location unit being configured to send a notification to the server during a predetermined event;
the server being configured to send a notification to the cellular device in response to receiving the notification from the mobile location unit; and
the cellular device being configured to send the mobile location unit a command in response to receiving the notification from the server.

9. A method for automatically measuring network parameters relating to wireless network environments with a server and at least one test terminal, the method comprising:
connecting to the server when the test terminal is turned on;
sending power-on registration data representing a current test state of the test terminal, wherein the power-on registration data includes information indicating a start, an interruption, or an end of the test in the at least one test terminal; and
if no test plan exists in the test terminal, automatically loading a test plan from the server;
if the test plan is loaded in the test terminal:
measuring the network parameters according to the test plan;
collecting and parsing the measured network parameters to obtain sets of measured network parameters; and
transmitting the sets of measured network parameters to the server when there is a data transmission request from the server or a predetermined set time according to the test plan.

10. The method of claim 9 wherein the test terminal is mobile.

11. The method of claim 10 wherein the network parameters are measured by using information representing a position at which the test terminal is currently located in the wireless environment at a test start time included in the test plan.

12. The method of claim 11 wherein position information is obtained from a global positioning system associated with the test terminal.

13. The method of claim 9 wherein the test terminal has a mobile station with a diagnostic monitor function to measure the network parameters and a mobile station with a data service function to communicate data with the server.

14. The method of claim 9 wherein the collecting and parsing step comprises decoding and storing the measured network parameters in a storage device.

15. The method of claim 14 wherein the transmitting step comprises:
turning on a mobile station with a data service function and connecting with the server using a modem or a RAS connection; and
sending the sets of decoded measured network parameters stored in the storage device to the server through the mobile station with the data service function.

16. The method of claim 9 wherein the wireless network environment is a CDMA system.

17. The method of claim 9 further comprising downloading updated application programs to the tester terminal from the server when the test terminal is initially connected to the server.

18. A system for automatically measuring network parameters relating to wireless network environments with a server and at least one test terminal, the system comprising:
means for connecting to the server when the test terminal is turned on;
means for sending power-on registration data representing a current test state of the test terminal, wherein the power-on registration data includes information indicating a start, an interruption, or an end of the test in the at least one test terminal; and
means for automatically loading a test plan from the server if no test plan exists in the test terminal;
means for measuring the network parameters according to the test plan;
means for collecting and parsing the measured network parameters to obtain sets of measured network parameters; and
means for transmitting the sets of measured network parameters to the server when there is a data transmission request from the server or a predetermined set time according to the test plan.

19. The system of claim 18 wherein the test terminal is disposed in a vehicle.

20. The system of claim 18 wherein the network parameters are measured by using information representing a position at which the test terminal is currently located in the wireless environment at a test start time included in the test plan.

21. The system of claim 20 wherein position information is obtained from a global positioning system associated with the test terminal.

22. The system of claim 18 wherein the test terminal has a mobile station with a diagnostic monitor function to measure the network parameters and a mobile station with a data service function to communicate data with the server.

23. The system of claim 18 wherein the collecting and parsing means includes means for decoding and storing the measured network parameters in a storage device.

24. The system of claim 18 wherein the transmitting means further comprises:
means for turning on a mobile station with a data service function and connecting with the server using a modem or a RAS connection; and
means for sending the sets of decoded measured network parameters stored in the storage device to the server through the mobile station with the data service function.

25. The system of claim 18 wherein the wireless network environment is a CDMA system.

26. The system of claim 18 further comprising means for downloading updated application programs to the tester terminal from the server when the test terminal is initially connected to the server.

27. An article of manufacture containing code for automatically measuring network parameters relating to wireless network environments with a server and at least one test terminal, comprising a computer usable media including at least one computer program embedded therein that is capable of causing at least one computer to perform:
connecting to the server when the test terminal is turned on;
sending power-on registration data representing a current test state of the test terminal, wherein the power-on registration data includes information indicating a start, an interruption, or an end of the test in the at least one test terminal; and
if no test plan exists in the test terminal, automatically loading a test plan from the server;
if a test plan is loaded in the test terminal:
measuring the network parameters according to the test plan;
collecting and parsing the measured network parameters to obtain sets of measured network parameters; and
transmitting the sets of measured network parameters to the server when there is a data transmission request from the server or a predetermined set time according to the test plan.
